(19) United States
(12) Patent Application Publication
(10) Pub. No.: US 2007/0012658 A1
(43) Pub. Date: Jan. 18, 2007

(54) Pvd component and coil refurbishing methods

(76) Inventor: John D. Mize, Spokane Valley, WA (US)

Correspondence Address: James E. Lake;Wells St. John, 601 West First Avenue, Suite 1300, Spokane, WA, 99201-3828, US

(21) Appl. No.: 10/557,281

(22) PCT Filed: Sep. 24, 2004
(86) PCT No.: PCT/US04/31288

§ 371 Date: Nov. 18, 2005

Related U.S. Application Data
(60) Provisional application No. 60/506,470, filed on Sep. 25, 2003.

(51) Int. Cl. B44C 1/22; C23F 1/00

(52) U.S. Cl. 216/52; 216/108

(57) ABSTRACT

A used PVD component refurbishing method includes providing a used PVD component, such as a RF coil (120), having a layer deposited on a component surface and first etching the deposited layer using a first acid-comprising etchant. After the first etching, the method includes entraining abrasive particles in a flow of gas, impinging the particles on the etched layer, and abrading the etched layer. After the abrading, the method includes second etching the abraded layer using a second acid-comprising etchant.

### RELATED APPLICATION DATA

This application claims priority to U.S. Provisional Application 60/506,470, which was filed on Sep. 25, 2003.

### TECHNICAL FIELD

The invention pertains to physical vapor deposition (PVD) components and coil refurbishing methods.

### BACKGROUND OF THE INVENTION

PVD components, including PVD coils, may accumulate layers of material deposited on the component surface during their use in PVD. The layers may contain the material being deposited by PVD or, possibly, some derivative thereof. Accumulation of the layers can increase the generation of contaminant particles during PVD and/or may impair operation of the PVD apparatus. Accordingly, accumulation of the layers may be monitored so that the component can be removed and discarded after reaching its usage limit. At such time, the removed component may be replaced with a new component. Replacing components manufactured from costly materials, for example tantalum, increases the cost of performing PVD.

Conventionally, attempts at refurbishing spent components meet with difficulty in adequately removing accumulated layers. Methods that adequately remove accumulated layers often damage the underlying original component or require lengthy processing for complete removal. Possible damage includes destroying desirable surface finishes and/or reducing dimensions of a component outside of tolerances. Bead blasting represents one known technique that typically damages the underlying original component if applied to an extent sufficient to adequately remove accumulated layers. Chemical etching represents one known technique that typically requires lengthy processing to adequately remove accumulated layers.

Other known techniques include applying chemical etching after bead blasting merely to remove blasting particles lodged in the component or merely to clean contaminants other than accumulated layers from the surface in brief (1 min (minute) or less) processing cycles. Such other combined techniques do not apply chemical etching in a manner that improves the extent to which bead blasting removes accumulated layers.

A possible improvement in PVD includes refurbishing components for further use by adequately removing accumulated layers in more efficient processes and/or limiting damage to the original component, thus extending the lifetime of PVD components and reducing the costs associated with PVD.

### SUMMARY OF THE INVENTION

In one aspect of the invention, a used PVD component refurbishing method includes providing a used PVD component having a layer deposited on a component surface and first etching the deposited layer using a first acid-comprising etchant. After the first etching, the method includes entraining abrasive particles in a flow of gas, impinging the particles on the etched layer, and abrading the etched layer. After the abrading, the method includes second etching the abraded layer using a second acid-comprising etchant.

In another aspect of the invention, a used PVD component refurbishing method includes providing a tantalum PVD component having a TaN layer deposited on a component surface during the PVD use and first etching the deposited layer for from greater than 1 to 15 min using an etchant that contains HF. After the first etching, the method includes entraining abrasive particles in a flow of gas, impinging the particles on the etched layer, and abrading the etched layer using process conditions sufficient to produce a Rₐ roughness of greater than 300 μin (8 μm). After the abrading, the method includes second etching the abraded layer with the etchant and producing bubbling that reaches a maximum rate. The second etching proceeds until the bubbling rate decreases to less than about 10% of the maximum rate.

In a further aspect of the invention, a used PVD coil refurbishing method includes providing a tantalum PVD coil used as a RF coil in a DC magnetron vacuum PVD reactor performing plasma sputtering, the coil having a TaN layer accumulated from PVD on a coil surface. The method includes first etching the deposited layer for from 1 to 15 min using an etchant that, aside from processing impurities, consists of a mixture of equal volumetric parts DI water, HF, and HNO₃. After the first etching, the method includes entraining a 1:1 mix of 16 and 24 grit (1.1 and 0.69 mm average diameter) alumina in a flow of air, impinging the alumina on the etched layer, and abrading the etched layer using process conditions sufficient to produce a Rₐ roughness of greater than 300 μin (8 μm). After the abrading, the method includes second etching the abraded layer with the etchant and producing bubbling that reaches a maximum rate. The second etching proceeds until the bubbling rate decreases to less than about 1% of the maximum rate.

### BRIEF DESCRIPTION OF THE DRAWINGS

Preferred embodiments of the invention are described below with reference to the following accompanying drawings.

FIG. 1 is a perspective view of a RF coil for a DC magnetron vacuum PVD reactor.

FIG. 2 is a side view of a mounting boss of the RF coil shown in FIG. 1.

FIG. 3 is a cross-sectional view of the mounting boss shown in FIG. 2.

FIG. 4 is a cross-sectional view of the mounting boss shown in FIG. 2 with interior surfaces of the mounting boss protected.

FIG. 5 is a SEM (scanning electron microscopy) micrograph of a used tantalum RF coil cross-section showing TaN deposited on a knurled surface of the coil.

FIG. 6 is a SEM micrograph of a used tantalum RF coil cross-section showing a refurbished surface.

### DETAILED DESCRIPTION OF THE PREFERRED EMBODIMENTS

According to one aspect of the invention, a used PVD component refurbishing method includes providing a used PVD component having a layer deposited on a component surface and first etching the deposited layer using a first acid-comprising etchant. After the first etching, the method includes entraining abrasive particles in a flow of gas, impinging the particles on the etched layer, and abrading the etched layer. After the abrading, the method includes second etching the abraded layer using a second acid-comprising etchant.

Exemplary components that may be refurbished according to the aspects of the invention include metal components, such as used PVD coils. The coils may be sized for installation in PVD apparatuses for 200 millimeter (mm) and 300 mm wafer PVD. The coils may be RF (radio frequency) coils used in a DC (direct current) magnetron vacuum PVD reactor performing plasma sputtering. The coil may be a tantalum coil and the deposited layer may include TaN deposited on the coil surface during PVD use. The coil may be removed from operation for refurbishing after the deposited layer reaches a thickness of from about 1 to about 450 micrometers (μm). Refurbishing may be desirable before the deposited layer thickness reaches a designated tolerance limit. Using the refurbishment methods described herein, TaN may be removed from tantalum coils-and the coils subsequently reused at least once, perhaps multiple times.

Also, the coil may include mounting bosses, also known as coil standoffs, used to mount the coil in a PVD apparatus. The mounting bosses may provide labyrinthine passageways, as known to those of ordinary skill, when mounted in the PVD apparatus. The passageways assist in maintaining electrical isolation of the coil from the surfaces on which it is mounted. Understandably, despite an initial electrical isolation, deposited conductive materials may short circuit across the electrical isolation. Accordingly, labyrinthine passageways allow deposition of conductive materials on exterior surfaces of the bosses as well as on the surfaces to which a coil is mounted without short circuiting the electrical isolation. The mounting bosses thus include interior surfaces and the aspects of the present invention may further include protecting the interior surfaces during the first etching and abrading.

Interior surfaces of the mounting bosses may be manufactured with close tolerances to provide the labyrinthine passageways and electrical isolation desired. Accordingly, the interior surfaces may be more susceptible to material losses during the first etching and the abrading in comparison to exterior surfaces of the mounting bosses and other portions of the PVD coil. Since a possibility exists that the layer may have deposited on interior surfaces, though to a lesser extent in comparison to exterior surfaces, aspects of the method include not protecting the interior surfaces of the mounting bosses during the second etching. In this manner, some part of the layer potentially deposited on interior surfaces of the mounting bosses can be removed with less risk of changing the interior surfaces of mounting bosses and exceeding tolerances.

One example of a RF coil from a DC magnetron vacuum PVD reactor that may be refurbished according to the aspects of the invention described herein includes RF coils from Endura Encore PVD apparatuses produced by Applied Materials in Santa Clara, Calif. The Endure Encore PVD apparatus is described in U.S. patent application Publication No. 2003/0116427 published on Jun. 26, 2003 and No. 2003/0089597 published on May 15, 2003. During ICP (inductively coupled plasma) sputtering, the RF coil in the Endura Encore PVD apparatus may accumulate a deposited layer. Observation indicates that, during TaN deposition using a tantalum coil, the deposited layer contains TaN. Refurbishing of the tantalum RF coil by removing the TaN according to the aspects of the invention provides a coil within tolerances reported to function adequately well in comparison to the original coil.

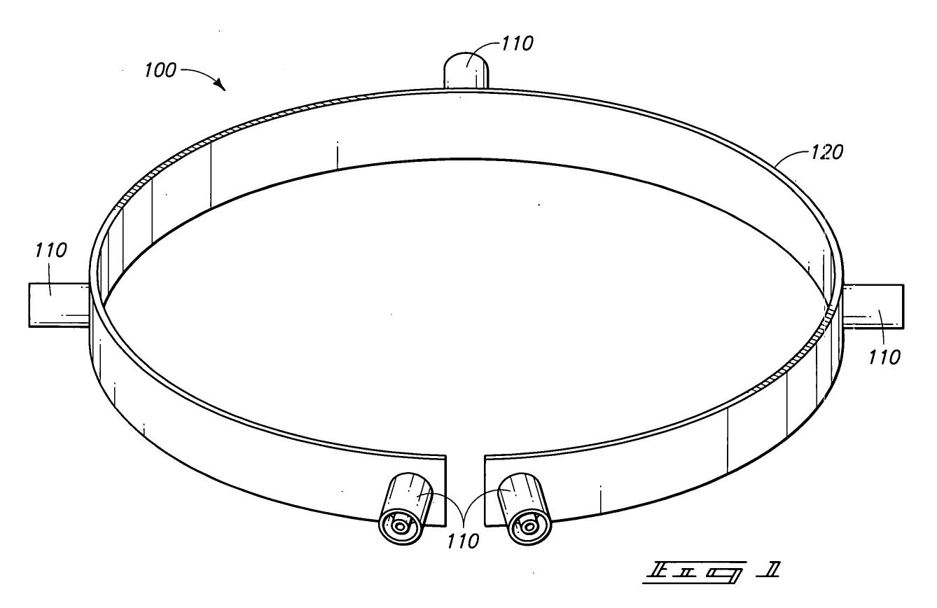

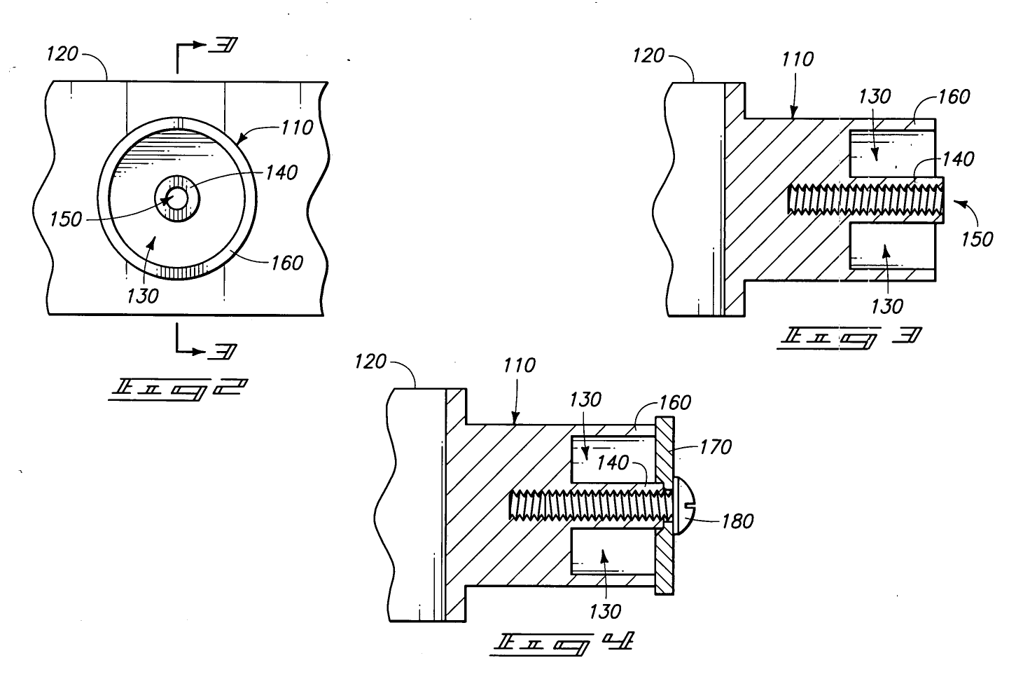

FIG. 1 is a perspective view of a coil assembly 100 representing a coil assembly that may be used in an Endura Encore PVD apparatus for 200 mm wafers. Coil assembly 100 includes multiple bosses 110 for mounting in the PVD apparatus attached to a coil 120. A coil assembly for 300 mm wafer PVD is essentially the same with a larger diameter and two additional bosses 110 for mounting. As known to those of ordinary skill, bosses 110 may be attached to coil 120 by a variety of means including, but not limited to, welding, bolting, and forming bosses 110 integrally with coil 120 during casting, etc. FIG. 2 is a side view of one boss 110 and a portion of coil 120. FIG. 3 is a cross-sectional view of boss 110 and coil 120 taken along line 3-3.

Boss 110 includes an outer cup 160 and an inner seat 140 defining a well 130 therebetween. Well 130 can be observed in FIGS. 1-3 to include interior surfaces with respect to outer surfaces of boss 110. Boss 110 also includes a screw hole 150 in seat 140 that provides additional interior surfaces of boss 110. Since a desire exists to maintain tolerances of screw hole 150 and well 130, the interior surfaces of such features may be protected during the first etching and the abrading. FIG. 4 shows a washer 170 mounted over well 130 and a screw 180 securing washer 170 in place. Washer 170 and/or screw 180 may consist of polytetrafluoroethylene (PTFE), polyethylene, aluminum or another material that is resistant to the first acid-comprising etchant and/or blocks the abrasive particles. For example, washer 170 and screw 180 may both consist of PTFE during the etching. Washer 170 may consist of aluminum and screw 180 may consist of polyethylene during the abrading. Washer 170 and screw 180 may be removed during the second etching as described.

In the various aspects of the invention, the first and second etchants can contain aqueous HF. The first and second etchants may be the same etchant that, aside from processing impurities, consists of a mixture of equal volumetric parts DI (deionized) water, HF, and HNO₃. The first etching may occur for from greater than 1 to 15 min for an average deposited layer thickness of from 1 to 450 μm. Longer etch times for thicker layers might be warranted. Typically, thickness may be from about 100 to about 300 μm; accordingly, the first etching may preferably occur for from 4 to 8 min.

The second etching may produce bubbling, reaching a maximum rate, and the second etching may proceed until the bubbling rate decreases to less than about 10% of the maximum rate or less than about 1% of the maximum rate. Preferably, the second etching proceeds until the bubbling stops. Observation indicates that bubbling during the second etching indicates the presence of remaining TaN. Accordingly, cessation of bubbling indicates complete or essentially complete removal of TaN. However, it is conceivable that the coil itself may also bubble, though at a decreased rate, during the second etching. Accordingly, an alternative end point may be a decrease in the bubbling rate as described above until bubbling substantially stops.

The abrading may include bead blasting with 16 to 36 grit (1.1 to 0.48 mm average diameter) alumina. A 1:1 mix of 16 and 24 grit (1.1 and 0.69 mm average diameter) alumina has proven effective. Other suitable abrasive particles include silicon carbide, garnet, glass bead, etc. The flow of gas entraining the abrasive particles may include one or more of air, argon, nitrogen, etc. at a pressure of from 25 to 100 psi (pounds/inch²) (0.17 to 0.69 MPa (MegaPascal)). The abrading may use process conditions sufficient to produce a Rₐ roughness of greater than 300 μin (microinch) (8 μm) before the second etching. Prior to the abrading, the component may include a knurled surface. Knurling often promotes adhesion of PVD layers on a component to reduce flaking and peeling of the layer onto a substrate intended for deposition. Accordingly, a desire exists to maintain some of the original roughness.

One advantage of the refurbishing methods described herein includes an increased rate of deposited layer removal compared to conventional techniques relying only upon chemical etching. The first etching, the abrading, and the second etching can remove the deposited layer at a rate greater than the same first etching and the same second etching performed without the abrading. Assuming the same etchant and actual etch time, aspects of the invention may increase the rate of removal by, among other features, dividing the etch into two etches and abrading between the etches.

Another advantage includes a decreased level of damage to the PVD component for an equivalent degree of deposited layer removal compared to conventional techniques relying only upon bead blasting or upon initial bead blasting followed by etching merely to remove blasting particles and/or clean contaminants. The first etching, the abrading, and the second etching can remove less of the PVD component surface than occurs in removing an equivalent thickness of the deposited layer by extending the abrading and performing the same second etching without the first etching. Assuming the same second etchant and actual second etch time, aspects of the invention remove less of the PVD component surface since additional bead blasting is applied to achieve equivalent deposited layer removal. In conventional techniques using both bead blasting and etching, etch time is typically very short so removal of the PVD component surface is even more significant for equivalent degrees of deposited layer removal.

The aspects of the invention described herein include first etching the deposited layer, abrading the etched layer, and second etching the abraded layer. It should be appreciated that additional cleaning or other processing steps may precede the three described steps or occur between such steps. For example, the first etching may be preceded by degreasing of the component using, for example, alkali soap, and rinsing of the degreased component. The first etching may be followed by a water rinse and subsequent drying using, for example, a dry stream of N₂ prior to the abrading. The second etching may be preceded by a water rinse and may be followed by a water rinse and subsequent drying prior to final packaging.

According to another aspect of the invention, a used PVD component refurbishing method includes providing a tantalum PVD component having a TaN layer deposited on a component surface during the PVD use and first etching the deposited layer for from greater than 1 to 15 min using an etchant that contains HF. After the first etching, the method includes entraining abrasive particles in a flow of gas, impinging the particles on the etched layer, and abrading the etched layer using process conditions sufficient to produce a Rₐ roughness of greater than 300 μin (8 μm). After the abrading, the method includes second etching the abraded layer with the etchant and producing bubbling that reaches a maximum rate. The second etching proceeds until the bubbling rate decreases to less than about 10% of the maximum rate.

According to further aspect of the invention, a used PVD coil refurbishing method includes providing a tantalum PVD coil used as a RF coil in a DC magnetron vacuum PVD reactor performing plasma sputtering, the coil having a TaN layer accumulated from PVD on a coil surface. The method includes first etching the deposited layer for from 1 to 15 min using an etchant that, aside from processing impurities, consists of a mixture of equal volumetric parts DI water, HF, and HNO₃. After the first etching, the method includes entraining a 1:1 mix of 16 and 24 grit (1.1 and 0.69 mm average diameter) alumina in a flow of air, impinging the alumina on the etched layer, and abrading the etched layer using process conditions sufficient to produce a Rₐ roughness of greater than 300 μin (8 μm). After the abrading, the method includes second etching the abraded layer with the etchant and producing bubbling that reaches a maximum rate. The second etching proceeds until the bubbling rate decreases to less than about 1% of the maximum rate.

### EXAMPLE 1

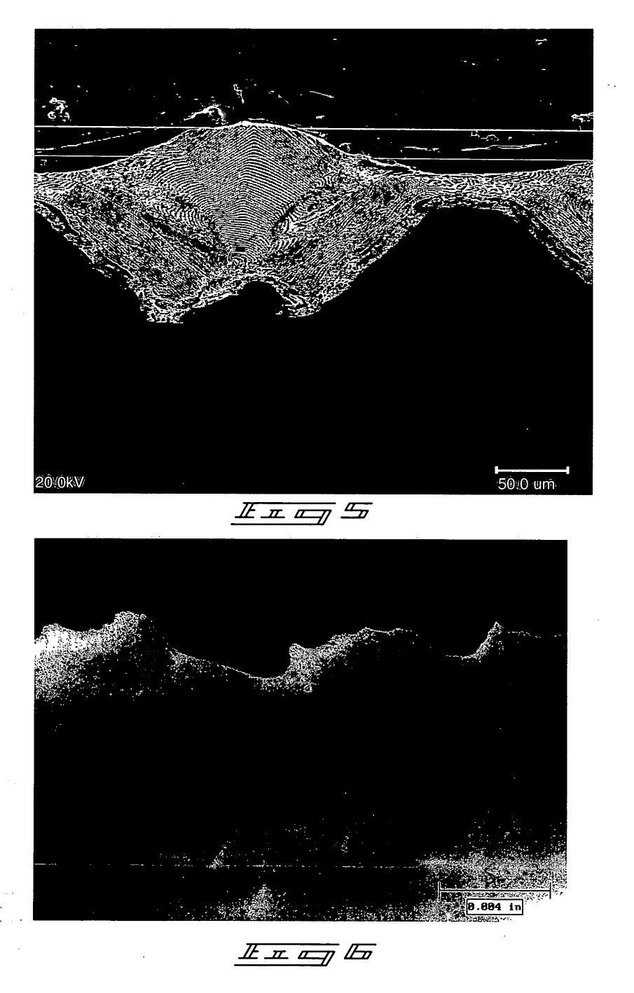

A 300 mm tantalum coil used for TaN deposition in an Endura Encore PVD apparatus was cleaned, degreased, and thoroughly rinsed. Representative sample coupons taken from the coil were analyzed by SEM and found to possess a TaN layer on their knurled surfaces. FIG. 5 is a micrograph of a coupon showing the gray peaks and valleys of the knurled surface with a light gray TaN layer formed thereon. The TaN layer in FIG. 5 exhibits a maximum thickness of about 144.9 μm and a minimum thickness of about 18.9 μm, however, thicknesses as high as 0.01132 in (287.5 μm) were measured.

### EXAMPLE 2

A coupon from Example 1 was etched and rinsed by immersing in a bath of equal volumetric parts DI water, HF, and HNO₃ for 12 min, draining briefly, immersing in DI water for 2.5 min, and spraying with DI water for 30 sec (seconds). The coupon was drained briefly, immersed in an ultrasonic rinsing sink containing DI water for 3 min, and drained briefly. The coupon was blown dry with a nitrogen gun set to 70-85 psi (0.48-0.59 MPa). Next, bead blasting occurred using 80 psi (0.6 MPa) air with a 1:1 mix of 16 and 24 grit (1.1 and 0.69 mm average diameter) alumina in a bead blasting chamber. Bead blasting proceeded to produce a Rₐ surface roughness of 483.2 μin (12.27 μm) on the inner diameter surface of the coil coupon and 413.6 μin (10.51 μm) on the outer diameter surface of the coil coupon. The respective original inner and outer Rₐ surface roughness was 474.4 and 1383 μin (12.05 and 35.13 μm). Thereafter, the etching was repeated. After rinsing and drying, analysis by SEM as shown in FIG. 6 revealed no remaining TaN layer.

Initial and final mass measurements indicated a mass loss of 8.22%. Thickness measurements indicated a dimensional change of less than 0.01265 in (0.3213 mm) within tolerances. Evenso, a belief existed that the coupon was etched more than necessary. Subsequent evaluation found that a first etch of 6 min and a second etch until bubbling stops (about 6 to 8 min) was adequate to achieve results equivalent to those shown in FIG. 6 for the subject 300 mm tantalum coil.

### EXAMPLE 3

A coupon from Example 1 was etched, rinsed, and dried as described in Example 2 without bead blasting except that only one etching occurred for 24 min. Analysis by SEM revealed remaining TaN with thicknesses as high as 0.00569 in (145 μm).

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

I claim:

1. A used PVD component refurbishing method comprising:
providing a used PVD component having a layer deposited on a component surface,
first etching the deposited layer using a first acid-comprising etchant;
after the first etching, entraining abrasive particles in a flow of gas, impinging the particles on the etched layer, and abrading the etched layer; and
after the abrading, second etching the abraded layer using a second acid-comprising etchant.

2. The method of claim 1 wherein the first etching, the abrading, and the second etching remove the deposited layer at a rate greater than the same first etching and the same second etching performed without the abrading.

3. The method of claim 1 wherein the first etching, the abrading, and the second etching remove less of the PVD component surface than occurs in removing an equivalent thickness of the deposited layer by extending the abrading and performing the same second etching without the first etching.

4. The method of claim 1 wherein the component comprises a coil.

5. The method of claim 4 wherein the coil was used as a RF coil in a DC magnetron vacuum PVD reactor performing plasma sputtering.

6. The method of claim 4 wherein the coil is a tantalum coil and the deposited layer comprises TaN deposited on the coil surface during the PVD use.

7. The method of claim 4 wherein the coil comprises mounting bosses with interior surfaces and the method further comprises protecting the interior surfaces during the first etching and the abrading, but not during the second etching.

8. The method of claim 1 wherein the component is a metal component.

9. The method of claim 1 wherein the first and second etchants comprise aqueous HF.

10. The method of claim 1 wherein the first and second etchants are the same etchant that, aside from processing impurities, consists of a mixture of equal volumetric parts deionized water, HF, and HNO₃.

11. The method of claim 1 wherein the first etching occurs for from greater than 1 to 15 min.

12. The method of claim 1 wherein the second etching produces bubbling, reaching a maximum rate, and the second etching proceeds until the bubbling rate decreases to less than about 10% of the maximum rate.

13. The method of claim 12 wherein the second etching proceeds until the bubbling stops.

14. The method of claim 1 wherein the abrading comprises bead blasting with 16 to 36 grit alumina.

15. The method of claim 1 wherein the abrading uses process conditions sufficient to produce a Rₐ roughness of greater than 300 μin before the second etching.

16. A used PVD component refurbishing method comprising:
providing a tantalum PVD component having a TaN layer deposited on a component surface during the PVD use;
first etching the deposited layer for from greater than 1 to 15 min using an etchant that comprises HF;
after the first etching, entraining abrasive particles in a flow of gas, impinging the particles on the etched layer, and abrading the etched layer using process conditions sufficient to produce a Rₐ roughness of greater than 300 μin; and
after the abrading, second etching the abraded layer with the etchant and producing bubbling that reaches a maximum rate, the second etching proceeding until the bubbling rate decreases to less than about 10% of the maximum rate.

17. The method of claim 16 wherein the first etching, the abrading, and the second etching remove the deposited layer at a rate greater than the same first etching and the same second etching performed without the abrading.

18. The method of claim 16 wherein the first etching, the abrading, and the second etching remove less of the PVD component surface than occurs in removing an equivalent thickness of the deposited layer by extending the abrading and performing the same second etching without the first etching.

19. The method of claim 16 wherein the component comprises a coil.

20. The method of claim 19 wherein the coil was used as a RF coil in a DC magnetron vacuum PVD reactor performing plasma sputtering.

21. The method of claim 19 wherein the coil comprises mounting bosses with interior surfaces and the method further comprises protecting the interior surfaces during the first etching and the abrading, but not during the second etching.

22. The method of claim 16 wherein, aside from processing impurities, the etchant consists of a mixture of equal volumetric parts deionized water, HF, and HNO₃.

23. The method of claim 16 wherein the second etching proceeds until the bubbling stops.

24. The method of claim 16 wherein the abrading comprises bead blasting with 16 to 36 grit alumina.

25. A used PVD coil refurbishing method comprising:
providing a tantalum PVD coil used as a RF coil in a DC magnetron vacuum PVD reactor performing plasma sputtering, the coil having a TaN layer accumulated from PVD on a coil surface;
first etching the deposited layer for from greater than 1 to 15 min using an etchant that, aside from processing impurities, consists of a mixture of equal volumetric parts deionized water, HF, and HNO₃;
after the first etching, entraining a 1:1 mix of 16 and 24 grit alumina in a flow of air, impinging the alumina on the etched layer, and abrading the etched layer using process conditions sufficient to produce a Rₐ roughness of greater than 300 μin;
after the abrading, second etching the abraded layer with the etchant and producing bubbling that reaches a maximum rate, the second etching proceeding until the bubbling rate decreases to less than about 1% of the maximum rate;
the first etching, the abrading, and the second etching removing the deposited layer at a rate greater than the same first etching and the same second etching performed without the abrading; and
the first etching, the abrading, and the second etching removing less of the PVD component surface than occurs in removing an equivalent thickness of the deposited layer by extending the abrading and performing the same second etching without the first etching.

26. The method of claim 25 wherein the coil comprises mounting bosses with interior surfaces and the method further comprises protecting the interior surfaces during the first etching and the abrading, but not during the second etching.

27. The method of claim 25 wherein the second etching proceeds until the bubbling stops.
